(19) United States
(12) Patent Application Publication
(10) Pub. No.: US 2019/0102757 A1
(43) Pub. Date: Apr. 4, 2019

(54) Method of constructing scalable blockchain by using KanBan to update off-chain transactions states

(71) Applicant: Paul Liu, Markham (CA)

(72) Inventor: Paul Liu, Markham (CA)

(21) Appl. No.: 15/719,818

(22) Filed: Sep. 29, 2017

(51) Int. Cl. G06Q 20/06; G06Q 20/36

(52) U.S. Cl. CPC G06Q 20/0658; G06Q 20/223; G06Q 20/36

(57) ABSTRACT

A method of constructing scalable blockchain by using KanBan to update off-chain transactions' states

A KanBan is a collection of data or data-tables managed as in memory database to maintain live states of a blockchain's off-chain transactions or off-chain accounts, it runs in a blockchain node computer or a separate computer connects to blockchain node, it resides either in computer's normal memory or GPU memory.

In a blockchain system, usually transactions are collected by blockchain nodes and included in a block to lock by consensus, however, due to consensus protocol as well as node computer's performance and network bandwidth limit, a blockchain system usually has low transaction process ability, for example, Bitcoin blockchain can process no more than 7 transactions per second only.

The so called off-chain transaction is a transaction that is not submitted to main blockchain only hold in local system temporarily until final submitting.

Off-chain transactions can be very large volume, two participants can perform multiple transactions back and forth before submitting to main blockchain for settlement, update and maintain accurate states in a global decentralized way for every off-chain account or address is important for banning double spend.

KanBan is dedicated for this purpose, when an off-chain transaction happens, it is sent to all KanBan nodes immediately, so that states of participants accounts or addresses are updated immediately in the blockchain wide.

With KanBan feature, a blockchain eco-system consists of main blockchain and localized nodes or side-chains in a unified value system can perform giant amount of transactions in a safe, reliable way, it enables a blockchain system to achieve great scalability.

Blockchain was first invented in Bitcoin to ensure integrity for data in blocks in a blockchain, time-sequenced blocks are locked by output/input strings link blocks in sequence like a chain, and use decentralized peer-to-peer network to store the blockchain database in distributed mutual mistrusted nodes, a block is generated by specific consensus rules.

Today, blockchain has been recognized as next generation internet—the value internet.

Normally a blockchain system is open to public, any one can join in as a node freely, therefore computer's performance and network bandwidth is quite different in whole blockchain wide, many of them may be moderate even low, that lead to a blockchain system difficult to scale, for example, Bitcoin can process less than 7 transactions per second only while Ethereum can process about 7 transactions per second, too.

Scalability is the bottleneck for blockchain technology, there are many proposals provided to resolve this problem, for example Lightning Network for Bitcoin, side-chain for other blockchains.

The method of constructing scalable blockchain by using KanBan to update off-chain transactions' states proposed is totally different with any existing approach, this method will achieve scalability for a blockchain eco-system consists of main blockchain, local nodes and side-chain in a unified value system easily and reliably.

In the scenario of this proposal, a blockchain consists of a main blockchain and some side-chains or localized central nodes which implements large quantity transactions. The main blockchain can't process too many transactions because its nodes are only with moderate process ability and bandwidth, suppose it can process no more than 7 transactions per second just like Bitcoin does, the large quantity transactions will happen in side-chains or localized central nodes, those transactions will not be submitted to blockchain until decide to, transactions between two participants can be multiple back and forth, they can be concluded as only one transaction at final when submit to main blockchain, this will decrease transactions quantity for main blockchain greatly, however, the accounts or addresses state are unknown to outside of its local network for they are not submitted to blockchain, it is risky because an account can execute double spend some where else.

This invention proposed a new concept in blockchain system—KanBan, which is a kind of in memory database or data management program running in main blockchain node-computer (or a separate computer connects to blockchain node), it may reside in computer's normal memory or GPU (graphics card) memory, it is dedicated for accepting off-chain transactions and update their states, by this way broadcasting localized off-chain transactions publicly to ban double spend globally even without submitting the off-chain transaction to main blockchain ledger.

When an off-chain transaction happens in a localized node or a side-chain, instead of sending the transaction to main blockchain for joining in ledger, it is sent to KanBan to join in watching list and update state for related accounts or addresses.

A wallet or other client application should check KanBan along with blockchain database to verify a transaction instead of checking blockchain only as usual does.

### SUMMARY

This invention of a method of constructing scalable blockchain by using KanBan to update off-chain transactions' states proposed an effective approach to make a unified value blockchain eco-system with great scalability, by using KanBan—a kind of in memory database to update localized off-chain transactions states, local off-chain transactions and their account states can be monitored globally in blockchain wide, so that to ban double spend and enable the blockchain system can process giant quantity of transactions in real time.

1. A method of constructing scalable blockchain by using KanBan to update off-chain transactions' states, to a blockchain system, using in memory database in main blockchain node-computers to update and maintain states for of-chain transactions, so that to ban double spend and make the blockchain scalable, the dedicated in memory database for updating off-chain transactions' states is called KanBan which means “watching board” in Chinese language.

2. The method of constructing scalable blockchain by using KanBan to update off-chain transactions' states of claim 1, wherein the KanBan is a kind of in memory database or data management program dedicated to accept off-chain transactions and update their states.

3. The method of constructing scalable blockchain by using KanBan to update off-chain transactions' states of claim 1, wherein the KanBan may run in the same computer as blockchain node or in a separate computer that connects to blockchain node via network.

4. The method of constructing scalable blockchain by using KanBan to update off-chain transactions' states of claim 1, wherein the KanBan as in memory database or data process program may reside in computer's normal memory or GPU (graphics card) memory.

5. The method of constructing scalable blockchain by using KanBan to update off-chain transactions' states of claim 1, wherein the KanBan is used to accept of-chain transactions may updates states for addresses or accounts of those off-chain transactions.

6. The method of constructing scalable blockchain by using KanBan to update off-chain transactions' states of claim 1, wherein an off-chain transaction can happen between two participants through dedicated wallets or happen in side-chain or in localized nodes.

7. The method of constructing scalable blockchain by using KanBan to update off-chain transactions' states of claim 1, wherein off-chain transactions can be multiple transactions between two participants in back and forth both ways.
